(19) United States
(12) Patent Application Publication
(10) Pub. No.: US 2026/0037823 A1
(43) Pub. Date: Feb. 5, 2026

(54) SYSTEMS AND METHODS FOR GENERALIZED USER REPRESENTATION WITH TRANSFER LEARNING

(71) Applicant: Spotify AB, Stockholm (SE)

(72) Inventors: Ghazal FAZELNIA, New York, NY (US); Sanket GUPTA, Ridgewood, NJ (US); A Young KEUM, West New York, NJ (US); Mark KOH, Golden, CO (US); Ian ANDERSON, Brooklyn, NY (US); Mounia LALMAS-ROELLEKE, London (GB)

(21) Appl. No.: 18/791,031

(22) Filed: Jul. 31, 2024

(51) Int. Cl. G06N 3/096; G06N 3/0455

(52) U.S. Cl. CPC G06N 3/096; G06N 3/0455

(57) ABSTRACT

A computing device receives an audio embedding space that includes a plurality of vectorized sets of features from a plurality of users, including a first vectorized set of features of a first user. The audio embedding space is generated using at least a first modality encoder that pre-processes features having a first feature type into the audio embedding space and a second modality encoder that pre-processes features having a second feature type into the audio embedding space. The computing device generates a generalized representation of the first user according to at least the audio embedding space. The computing device provides the generalized representation of the first user to two or more task models. Each task model is configured to be trained to perform a respective task.

### TECHNICAL FIELD

The disclosed embodiments relate generally to media provider systems, and, in particular, a user representation model for large-scale recommender systems to effectively represent diverse user tastes in a generalized manner.

### BACKGROUND

Access to electronic media, such as music, videos, podcast, and audiobook content, has expanded dramatically over time. As a departure from physical media, media content providers stream media to electronic devices across wireless networks, improving the convenience with which users can digest and experience such content.

### SUMMARY

Media content providers can provide personalized recommendations to users by learning from their implicit and/or explicit feedback. One of the challenges facing media content providers is the cold-start user problem, where there is a lack of implicit or explicit signals from new users. In the case of large-scale music streaming services, the ability to accurately capture user interests and model them becomes even more challenging, because these services typically deliver catalogues with tens of millions of music tracks to hundreds of millions of users. The catalogues can be impacted by seasonality effects, exogenous events, and continuous additions of new music tracks that alter perceived relationships between tracks. The tracks are often short in duration and many tracks can be played together in a listening session, frequently without any user feedback. Furthermore, users may also have conflicting interests to both revisit their favorite tracks and to discover new music to diversify their listening experiences.

User representations (e.g., user representation models) can capture user interests and enable personalization across products in media content streaming services. They can also be utilized across a variety of downstream applications. Creating a generalized user representation that covers and adapts to a wide range of user tastes and preferences remains a core problem in large-scale media content streaming services today.

In the disclosed embodiments, systems and methods are provided for generating a generalized (e.g., generic) user representations, which can then be used to complete a plurality of other tasks. In some embodiments, the generalized user representation of a user is generated using information about the user, including content-based features (e.g., audio features for content items that have been consumed by the user) and collaborative-based features (e.g., collaborative features based on co-occurrence of content items within a playlist), encoding the information about the user using one or more modality encoders, and feeding the encoded information about the user to a machine learning model. The generalized representation of the user is then provided to a plurality of task models, each of which takes the generalized representation of the user and one or more other task-specific features, to perform the task (e.g., ranking, search, music recommendations, discovery, etc.).

To that end, in accordance with some embodiments, a method is provided. The method includes receiving an audio embedding space that includes a plurality of vectorized sets of features from a plurality of users, including a first vectorized set of features of a first user. The audio embedding space is generated using at least a first modality encoder that pre-processes features having a first feature type into the audio embedding space and a second modality encoder that pre-processes features having a second feature type into the audio embedding space. The method includes generating a generalized representation of the first user according to at least the audio embedding space. The method also includes providing the generalized representation of the first user to two or more task models, each task model configured to be trained to perform a respective task.

In accordance with some embodiments, a computer system (e.g., an electronic device) is provided. The computer system includes one or more processors and memory storing one or more programs. The one or more programs include instructions for performing any of the methods described herein.

In accordance with some embodiments, a non-transitory computer-readable storage medium is provided. The non-transitory computer-readable storage medium stores one or more programs for execution by a computer system with one or more processors. The one or more programs comprising instructions for performing any of the methods described herein.

Thus, systems are provided with improved methods for generating generalized user representations for application to downstream models.

### BRIEF DESCRIPTION OF THE DRAWINGS

The embodiments disclosed herein are illustrated by way of example, and not by way of limitation, in the figures of the accompanying drawings. Like reference numerals refer to corresponding parts throughout the drawings and specification.

FIG. 1 is a block diagram illustrating a media content delivery system, in accordance with some embodiments.

FIG. 2 is a block diagram illustrating an electronic device, in accordance with some embodiments.

FIG. 3 is a block diagram illustrating a media content server, in accordance with some embodiments.

FIG. 4 illustrates a user representation model architecture, in accordance with some embodiments.

FIGS. 5A and 5B illustrate output embeddings that are output by modality encoders over different time horizons, in accordance with some embodiments.

FIG. 5C illustrates using a modality encoder to generate new user onboarding embeddings, in accordance with some embodiments.

FIG. 6 illustrates a user representation model that receives inputs from different modality encoders, in accordance with some embodiments.

FIG. 7 illustrates downstream model tasks before (left) and after (right) incorporating transfer learning with a user representation, in accordance with some embodiments.

FIG. 8 illustrates near-real time inference of user representations, in accordance with some embodiments.

FIG. 9 illustrates an example transfer learning model chain that includes batch management, in accordance with some embodiments.

FIGS. 10A-10D are flow diagrams illustrating a method of generating a generalized representation of users, in accordance with some embodiments.

### DETAILED DESCRIPTION

Reference will now be made to embodiments, examples of which are illustrated in the accompanying drawings. In the following description, numerous specific details are set forth in order to provide an understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It will also be understood that, although the terms first, second, etc. are, in some instances, used herein to describe various elements, these elements should not be limited by these terms. These terms are used only to distinguish one element from another. For example, a first electronic device could be termed a second electronic device, and, similarly, a second electronic device could be termed a first electronic device, without departing from the scope of the various described embodiments. The first electronic device and the second electronic device are both electronic devices, but they are not the same electronic device.

The terminology used in the description of the various embodiments described herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

### Media Content Delivery Service

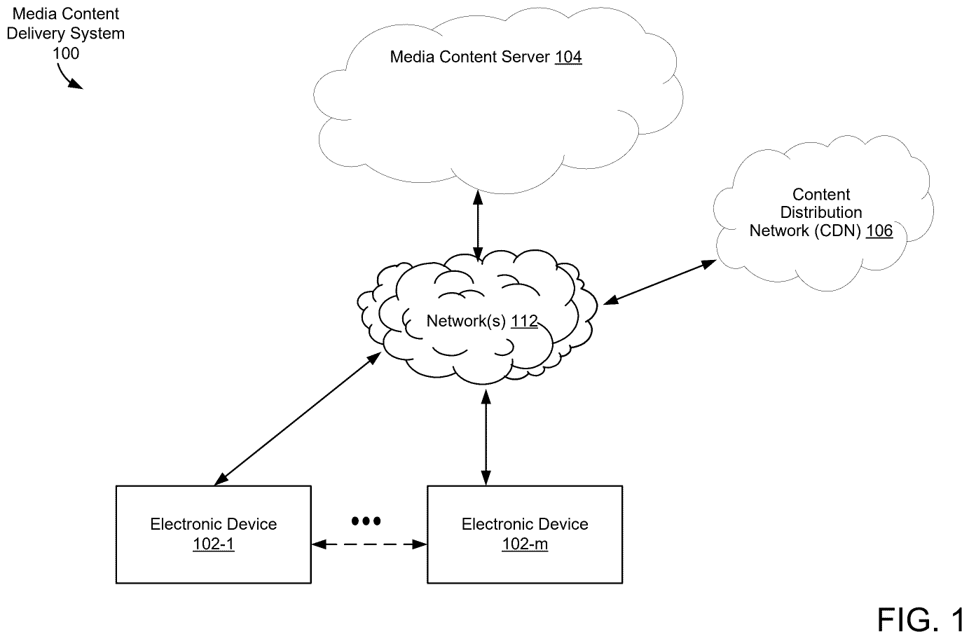

FIG. 1 is a block diagram illustrating a media content delivery system 100, in accordance with some embodiments. The media content delivery system 100 includes one or more electronic devices 102 (e.g., electronic device 102-1 to electronic device 102-m, where m is an integer greater than one), one or more media content servers 104, and/or one or more content distribution networks (CDNs) 106. The one or more media content servers 104 are associated with (e.g., at least partially compose) a media-providing service. The one or more CDNs 106 store and/or provide one or more content items (e.g., to electronic devices 102). In some embodiments, the CDNs 106 are included in the media content servers 104. One or more networks 112 communicably couple the components of the media content delivery system 100. In some embodiments, the one or more networks 112 include public communication networks, private communication networks, or a combination of both public and private communication networks. For example, the one or more networks 112 can be any network (or combination of networks) such as the Internet, other wide area networks (WAN), local area networks (LAN), virtual private networks (VPN), metropolitan area networks (MAN), peer-to-peer networks, and/or ad-hoc connections.

In some embodiments, an electronic device 102 is associated with one or more users. In some embodiments, an electronic device 102 is a personal computer, mobile electronic device, wearable computing device, laptop computer, tablet computer, mobile phone, feature phone, smart phone, an infotainment system, digital media player, a speaker, television (TV), and/or any other electronic device capable of presenting media content (e.g., controlling playback of media items, such as music tracks, podcasts, videos, etc.). Electronic devices 102 may connect to each other wirelessly and/or through a wired connection (e.g., directly through an interface, such as an HDMI interface). In some embodiments, electronic devices 102-1 and 102-m are the same type of device (e.g., electronic device 102-1 and electronic device 102-m are both speakers). Alternatively, electronic device 102-1 and electronic device 102-m include two or more different types of devices.

In some embodiments, electronic devices 102-1 and 102-m send and receive media-control information through network(s) 112. For example, electronic devices 102-1 and 102-m send media control requests (e.g., requests to play music, podcasts, movies, videos, or other media items, or playlists thereof) to media content server 104 through network(s) 112. Additionally, electronic devices 102-1 and 102-m, in some embodiments, also send indications of media content items to media content server 104 through network(s) 112. In some embodiments, the media content items are uploaded to electronic devices 102-1 and 102-m before the electronic devices forward the media content items to media content server 104.

In some embodiments, electronic device 102-1 communicates directly with electronic device 102-m (e.g., as illustrated by the dotted-line arrow), or any other electronic device 102. As illustrated in FIG. 1, electronic device 102-1 is able to communicate directly (e.g., through a wired connection and/or through a short-range wireless signal, such as those associated with personal-area-network (e.g., BLUETOOTH/BLE) communication technologies, radio-frequency-based near-field communication technologies, infrared communication technologies, etc.) with electronic device 102-m. In some embodiments, electronic device 102-1 communicates with electronic device 102-m through network(s) 112. In some embodiments, electronic device 102-1 uses the direct connection with electronic device 102-m to stream content (e.g., data for media items) for playback on the electronic device 102-m.

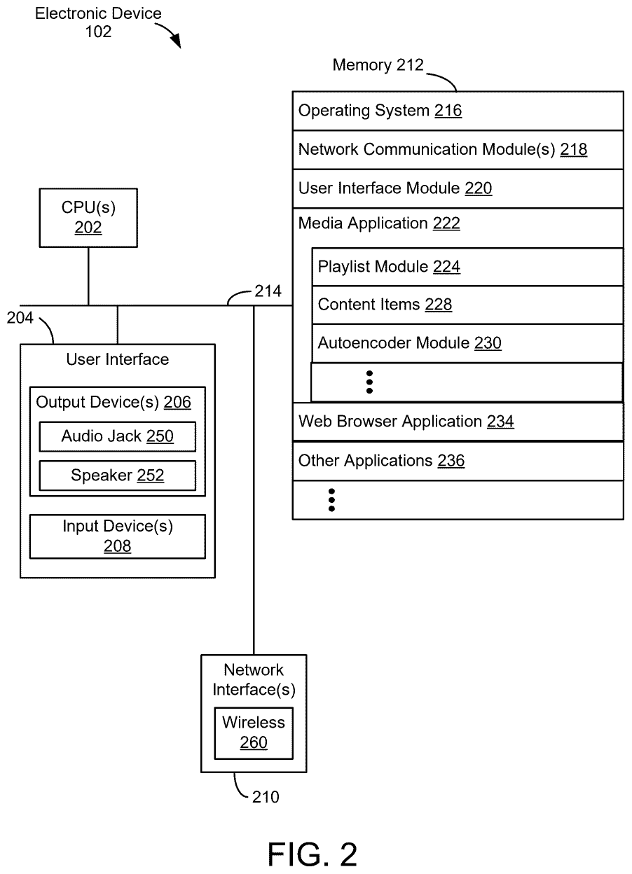

In some embodiments, electronic device 102-1 and/or electronic device 102-m include a media application 222 (FIG. 2) that allows a respective user of the respective electronic device to upload (e.g., to media content server 104), browse, request (e.g., for playback at the electronic device 102), and/or present media content (e.g., control playback of music tracks, playlists, videos, etc.). In some embodiments, one or more media content items are stored locally by an electronic device 102 (e.g., in memory 212 of the electronic device 102, FIG. 2). In some embodiments, one or more media content items are received by an electronic device 102 in a data stream (e.g., from the CDN 106 and/or from the media content server 104). The electronic device(s) 102 are capable of receiving media content (e.g., from the CDN 106) and presenting the received media content. For example, electronic device 102-1 may be a component of a network-connected audio/video system (e.g., a home entertainment system, a radio/alarm clock with a digital display, or an infotainment system of a vehicle). In some embodiments, the CDN 106 sends media content to the electronic device(s) 102.

In some embodiments, the CDN 106 stores and provides media content (e.g., media content requested by the media application 222 of electronic device 102) to electronic device 102 via the network(s) 112. Content (also referred to herein as “media items,” “media content items,” and “content items”) is received, stored, and/or served by the CDN 106. In some embodiments, content includes audio (e.g., music, spoken word, podcasts, audiobooks, etc.), video (e.g., short-form videos, music videos, television shows, movies, clips, previews, etc.), text (e.g., articles, blog posts, emails, etc.), image data (e.g., image files, photographs, drawings, renderings, etc.), games (e.g., 2- or 3-dimensional graphics-based computer games, etc.), or any combination of content types (e.g., web pages that include any combination of the foregoing types of content or other content not explicitly listed). In some embodiments, content includes one or more audio media items (also referred to herein as “audio items,” “tracks,” and/or “audio tracks”).

In some embodiments, media content server 104 receives media requests (e.g., commands) from electronic devices 102. In some embodiments, media content server 104 includes a voice API, a connect API, and/or key service. In some embodiments, media content server 104 validates (e.g., using key service) electronic devices 102 by exchanging one or more keys (e.g., tokens) with electronic device(s) 102.

In some embodiments, media content server 104 and/or CDN 106 stores one or more playlists (e.g., information indicating a set of media content items). For example, a playlist is a set of media content items defined by a user and/or defined by an editor associated with a media-providing service. The description of the media content server 104 as a “server” is intended as a functional description of the devices, systems, processor cores, and/or other components that provide the functionality attributed to the media content server 104. It will be understood that the media content server 104 may be a single server computer, or may be multiple server computers. Moreover, the media content server 104 may be coupled to CDN 106 and/or other servers and/or server systems, or other devices, such as other client devices, databases, content delivery networks (e.g., peer-to-peer networks), network caches, and the like. In some embodiments, the media content server 104 is implemented by multiple computing devices working together to perform the actions of a server system (e.g., cloud computing).

FIG. 2 is a block diagram illustrating an electronic device 102 (e.g., electronic device 102-1 and/or electronic device 102-m, FIG. 1), in accordance with some embodiments. The electronic device 102 includes one or more central processing units (CPU(s), i.e., processors or cores) 202, one or more network (or other communications) interfaces 210, memory 212, and one or more communication buses 214 for interconnecting these components. The communication buses 214 optionally include circuitry (sometimes called a chipset) that interconnects and controls communications between system components.

In some embodiments, the electronic device 102 includes a user interface 204, including output device(s) 206 and/or input device(s) 208. In some embodiments, the input devices 208 include a keyboard, mouse, or track pad. Alternatively, or in addition, in some embodiments, the user interface 204 includes a display device that includes a touch-sensitive surface, in which case the display device is a touch-sensitive display. In electronic devices that have a touch-sensitive display, a physical keyboard is optional (e.g., a soft keyboard may be displayed when keyboard entry is needed). In some embodiments, the output devices (e.g., output device(s) 206) include a speaker 252 (e.g., speakerphone device) and/or an audio jack 250 (or other physical output connection port) for connecting to speakers, earphones, headphones, or other external listening devices. Furthermore, some electronic devices 102 use a microphone and voice recognition device to supplement or replace the keyboard. Optionally, the electronic device 102 includes an audio input device (e.g., a microphone) to capture audio (e.g., speech from a user).

In some embodiments, the one or more network interfaces 210 include wireless and/or wired interfaces for receiving data from and/or transmitting data to other electronic devices 102, a media content server 104, a CDN 106, and/or other devices or systems. In some embodiments, data communications are carried out using any of a variety of custom or standard wireless protocols (e.g., NFC, RFID, IEEE 802.15.4, Wi-Fi, ZigBee, 6LoWPAN, Thread, Z-Wave, Bluetooth, ISA100.11a, WirelessHART, MiWi, etc.). Furthermore, in some embodiments, data communications are carried out using any of a variety of custom or standard wired protocols (e.g., USB, Firewire, Ethernet, etc.). For example, the one or more network interfaces 210 include a wireless interface 260 for enabling wireless data communications with other electronic devices 102, media presentations systems, and/or or other wireless (e.g., Bluetooth-compatible) devices (e.g., for streaming audio data to the media presentations system of an automobile). Furthermore, in some embodiments, the wireless interface 260 (or a different communications interface of the one or more network interfaces 210) enables data communications with other WLAN-compatible devices (e.g., a media presentations system) and/or the media content server 104 (via the one or more network(s) 112, FIG. 1).

In some embodiments, electronic device 102 includes one or more sensors including, but not limited to, accelerometers, gyroscopes, compasses, magnetometer, light sensors, near field communication transceivers, barometers, humidity sensors, temperature sensors, proximity sensors, range finders, and/or other sensors/devices for sensing and measuring various environmental conditions.

Memory 212 includes high-speed random-access memory, such as DRAM, SRAM, DDR RAM, or other random-access solid-state memory devices; and may include non-volatile memory, such as one or more magnetic disk storage devices, optical disk storage devices, flash memory devices, or other non-volatile solid-state storage devices. Memory 212 may optionally include one or more storage devices remotely located from the CPU(s) 202. Memory 212, or alternately, the non-volatile memory solid-state storage devices within memory 212, includes a non-transitory computer-readable storage medium. In some embodiments, memory 212 or the non-transitory computer-readable storage medium of memory 212 stores the following programs, modules, and data structures, or a subset or superset thereof:
an operating system 216 that includes procedures for handling various basic system services and for performing hardware-dependent tasks;
network communication module(s) 218 for connecting the electronic device 102 to other computing devices (e.g., media presentation system(s), media content server 104, and/or other client devices) via the one or more network interface(s) 210 (wired or wireless) connected to one or more network(s) 112;
a user interface module 220 that receives commands and/or inputs from a user via the user interface 204 (e.g., from the input devices 208) and provides outputs for playback and/or display on the user interface 204 (e.g., the output devices 206);
a media application 222 (e.g., an application for accessing a media-providing service of a media content provider associated with media content server 104) for uploading, browsing, receiving, processing, presenting, and/or requesting playback of media (e.g., media items). In some embodiments, media application 222 includes a media player, a streaming media application, and/or any other appropriate application or component of an application. In some embodiments, media application 222 is used to monitor, store, and/or transmit (e.g., to media content server 104) data associated with user behavior. In some embodiments, media application 222 also includes the following modules (or sets of instructions), or a subset or superset thereof:
   a playlist module 224 for storing sets of media items for playback in a predefined order, the media items selected by the user (e.g., for a user-curated playlist) and/or the media items curated without user input (e.g., by the media content provider);
   a content items module 228 for storing media items, including audio items such as podcasts and songs, for playback and/or for forwarding requests for media content items to the media content server; and
   an autoencoder module 230 for generating generalized representations of users and providing the generalized representations to downstream task models;
a web browser application 234 for accessing, viewing, and interacting with web sites; and
other applications 236, such as applications for word processing, calendaring, mapping, weather, stocks, time keeping, virtual digital assistant, presenting, number crunching (spreadsheets), drawing, instant messaging, e-mail, telephony, video conferencing, photo management, video management, a digital music player, a digital video player, 2D gaming, 3D (e.g., virtual reality) gaming, electronic book reader, and/or workout support.

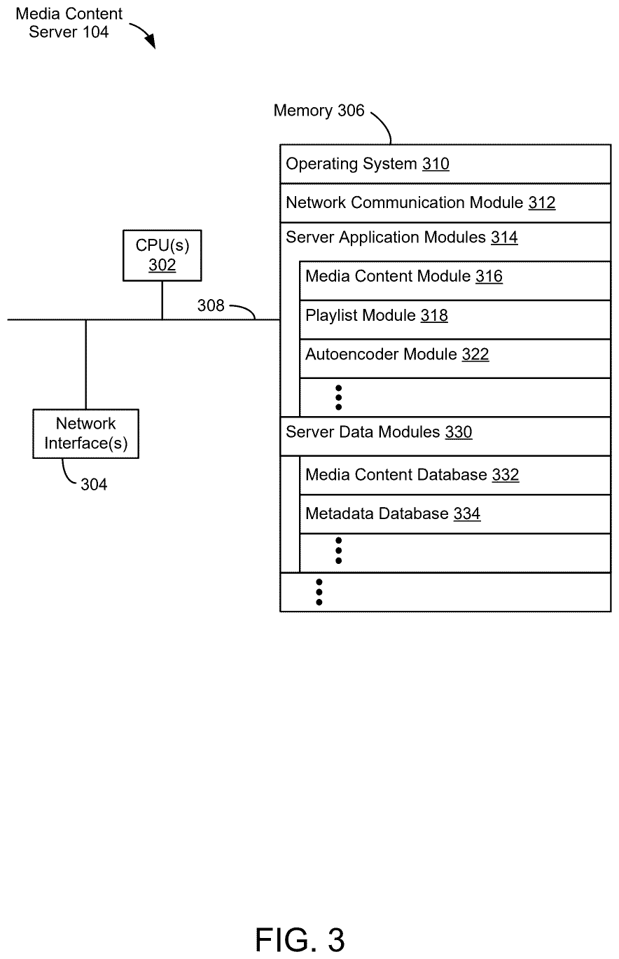

FIG. 3 is a block diagram illustrating a media content server 104, in accordance with some embodiments. The media content server 104 typically includes one or more central processing units/cores (CPUs) 302, one or more network interfaces 304, memory 306, and one or more communication buses 308 for interconnecting these components.

Memory 306 includes high-speed random access memory, such as DRAM, SRAM, DDR RAM, or other random access solid-state memory devices; and may include non-volatile memory, such as one or more magnetic disk storage devices, optical disk storage devices, flash memory devices, or other non-volatile solid-state storage devices. Memory 306 optionally includes one or more storage devices remotely located from one or more CPUs 302. Memory 306, or, alternatively, the non-volatile solid-state memory device(s) within memory 306, includes a non-transitory computer-readable storage medium. In some embodiments, memory 306, or the non-transitory computer-readable storage medium of memory 306, stores the following programs, modules and data structures, or a subset or superset thereof:
an operating system 310 that includes procedures for handling various basic system services and for performing hardware-dependent tasks;
a network communication module 312 that is used for connecting the media content server 104 to other computing devices via one or more network interfaces 304 (wired or wireless) connected to one or more networks 112;
one or more server application modules 314 for performing various functions with respect to providing and managing a content service, the server application modules 314 including, but not limited to, one or more of:
   a media content module 316 for storing one or more media content items and/or sending (e.g., streaming), to the electronic device, one or more requested media content item(s);
   a playlist module 318 for storing and/or providing (e.g., streaming) sets of media content items to the electronic device; and
   an autoencoder module 322 for generating generalized representations of users and providing the generalized representations to downstream task models;
one or more server data module(s) 330 for handling the storage of and/or access to media items and/or metadata relating to the media items; in some embodiments, the one or more server data module(s) 330 include:
   a media content database 332 for storing media items; and
   a metadata database 334 for storing metadata relating to the media items, including a genre associated with the respective media items.

In some embodiments, the media content server 104 includes web or Hypertext Transfer Protocol (HTTP) servers, File Transfer Protocol (FTP) servers, as well as web pages and applications implemented using Common Gateway Interface (CGI) script, PHP Hyper-text Preprocessor (PHP), Active Server Pages (ASP), Hyper Text Markup Language (HTML), Extensible Markup Language (XML), Java, JavaScript, Asynchronous Javascript and XML (AJAX), XHP, Javelin, Wireless Universal Resource File (WURFL), and the like.

Each of the above identified modules stored in memory 212 and 306 corresponds to a set of instructions for performing a function described herein. The above identified modules or programs (i.e., sets of instructions) need not be implemented as separate software programs, procedures, or modules, and thus various subsets of these modules may be combined or otherwise re-arranged in various embodiments. In some embodiments, memory 212 and 306 optionally store a subset or superset of the respective modules and data structures identified above. Furthermore, memory 212 and 306 optionally store additional modules and data structures not described above.

Although FIG. 3 illustrates the media content server 104 in accordance with some embodiments, FIG. 3 is intended more as a functional description of the various features that may be present in one or more media content servers than as a structural schematic of the embodiments described herein. In practice, and as recognized by those of ordinary skill in the art, items shown separately could be combined and some items could be separated. For example, some items shown separately in FIG. 3 could be implemented on single servers and single items could be implemented by one or more servers. In some embodiments, media content database 332 and/or metadata database 334 are stored on devices (e.g., CDN 106) that are accessed by media content server 104. The actual number of servers used to implement the media content server 104, and how features are allocated among them, will vary from one implementation to another and, optionally, depends in part on the amount of data traffic that the server system handles during peak usage periods as well as during average usage periods.

### Generalized User Representation With Transfer Learning

The processes and techniques described below may be performed at the devices and systems described above (e.g., the media content server 104 and/or one or more of the electronic devices 120). Some embodiments are directed to a framework for generating user representations that can be generalized across many downstream applications and are well suited for cold start user experiences.

Notations and definitions. U is the set of users and M is the set of tracks. For each user u∈U, the features are denoted as xᵤ∈R^{d}, where d denotes the dimensionality of the input feature space. Suppose also that zᵤ∈R^{k} denotes the user representation for user u that exists in the representation space Ω. In some embodiments, to learn and compress the information effectively, k is set such that k<<d. Further, without loss of generality, suppose an audio (e.g., music) streaming dataset includes user-track interactions. For each user u, cᵤ is the concatenation of user-specific information including context, demographics, affinities, and activities. mᵤ is the set of all the tracks that user u has interacted with. For each track m, the track features are defined as tₘ.

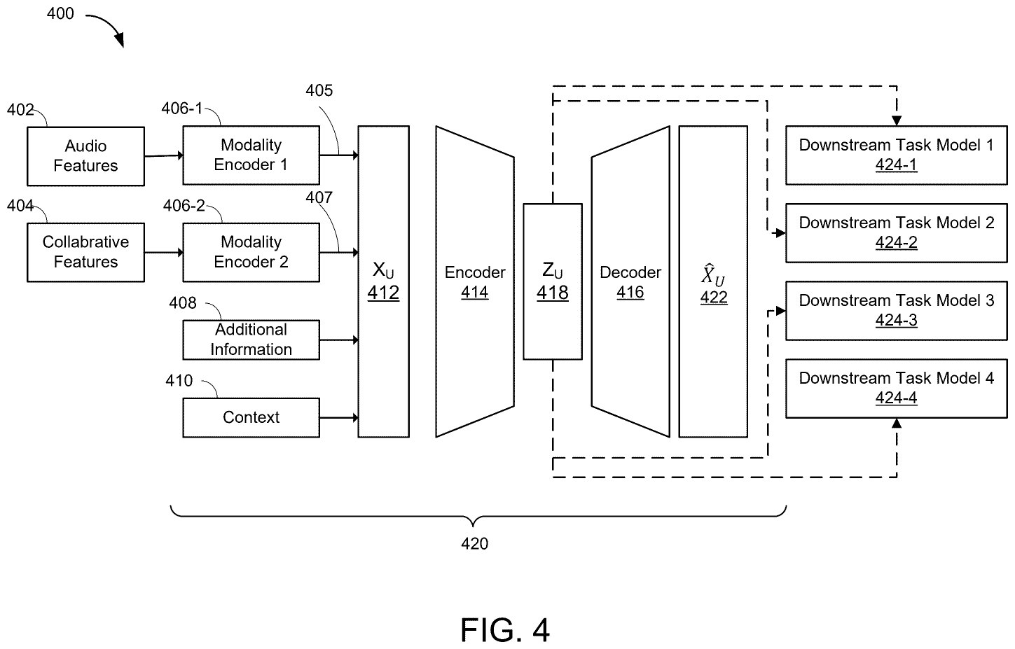

FIG. 4 illustrates a user representation model architecture 400, in accordance with some embodiments. The model architecture 400 comprises an autoencoder model 420 (e.g., a deep learning network) that includes an encoder 414 and a decoder 416. Encoder 414 and decoder 416 are deep neural networks with multiple hidden layers. Together, they compress various input features in audio embedding space (X_{U}) 412 into a representation space (Z_{U}) 418 (e.g., a latent space) that includes generalized representations of users. In some embodiments, the input features capture both short-term and long-term trends in users' music taste and the model can learn on both simultaneously. The features are designed so that the user representation is generalizable to capture holistic understanding of the user at any given time. Autoencoder model 420 learns a compressed representation of the data in Z_{U} 418, and then reconstructs that data from (Z_{U}) 418 to generate reconstructed input \hat{X}_{U} 422.

In some embodiments, autoencoder model 420 is trained on an offline training dataset that is created using streaming information from a user base of a media content provider. For example, in some embodiments, the training dataset contains instances of over 600 million users on over 30 million items in the catalog of the media content provider. Autoencoder model 420 is regularized using a small dropout to ensure generalization and to avoid over-fitting. A scaled exponential linear unit (SELU) activation function is used in both encoder 414 and decoder 416 as it provides better convergence than other activation functions.

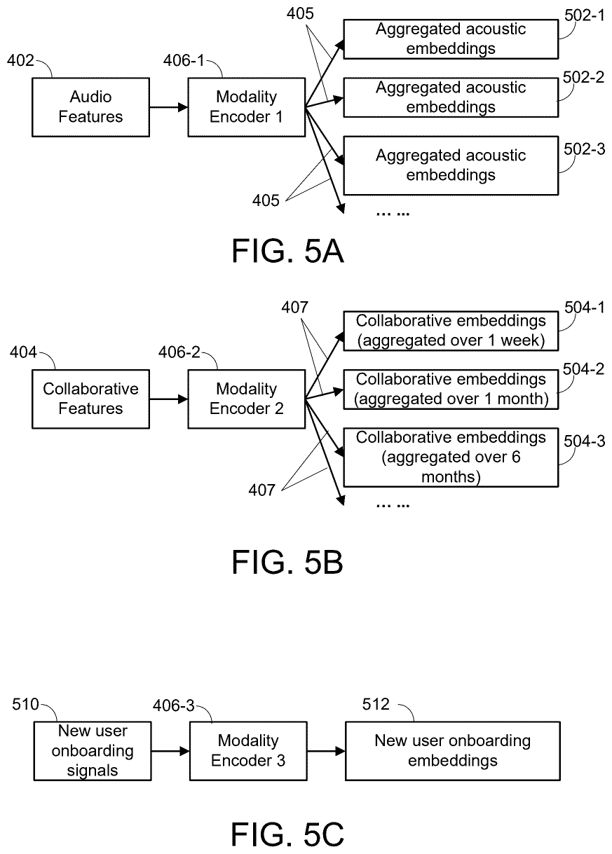

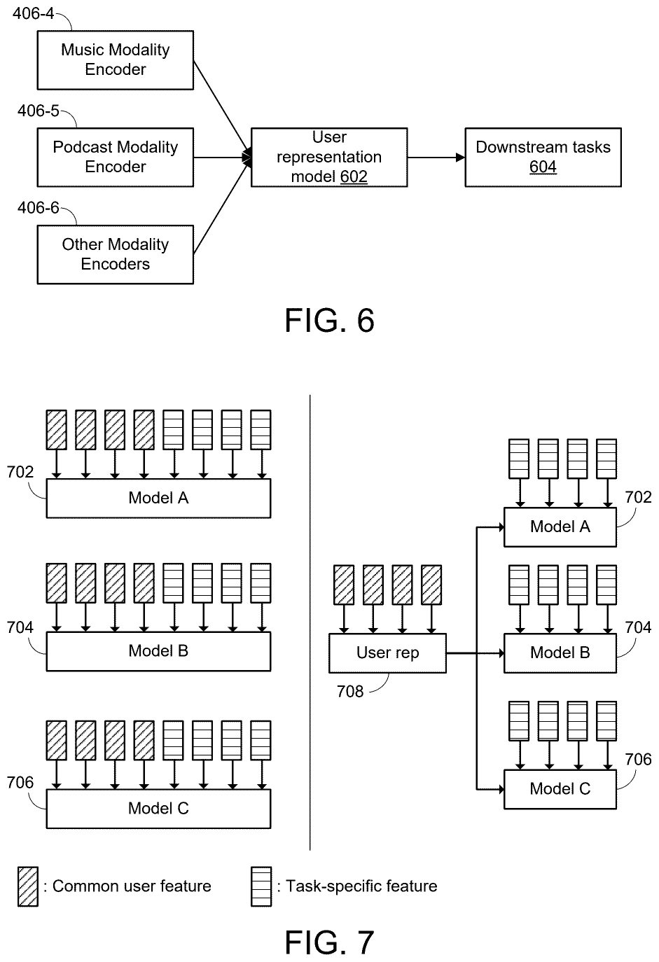

In some embodiments, the model architecture 400 employs a two-stage process that combines representation learning and transfer learning. The first stage of two-stage process involves generating (e.g., processing) an audio embedding space (X_{U}) 412 (e.g., a track space). In some instances, to handle the scale of the track space (e.g., audio track space) and/or to avoid using particular track identifiers, the autoencoder model 420 includes one or more modality encoders 406 (e.g., including modality encoder 406-1, modality encoder 406-2, modality encoder 406-3 (FIG. 5C), modality encoder 406-4 (FIG. 6), modality encoder 406-5 (FIG. 6), and/or modality encoder 406-6 (FIG. 6)) that are trained to be configured to pre-process track features. In some embodiments, the autoencoder model 420 includes a first modality encoder 406-1 that processes audio features 402 (e.g., track audio) to obtain acoustic embeddings 405 representing acoustic information of audio. The acoustic embeddings 405 are added to the audio embedding space 412. In some embodiments, the acoustic embeddings 405 comprise n-dimensional real-valued vectors (e.g., n=60, 80 or 100) mapping track into audio embedding space 412.

In some embodiments, the autoencoder model 420 includes a first modality encoder 406-2 (e.g., collaborative modality encoder) that processes collaborative features 404 to obtain collaborative embeddings 407 representing information of playlist co-occurrence of tracks, tracks that are listened to a same user and/or similar users, tracks that are consumed within a same playback session and/or within a threshold amount of time of each other, and/or other collaborative occurrences of tracks. The collaborative embeddings 407 are also added to audio embedding space 412. For example, if two tracks frequently appeared together in a playlist, they have latent similarities and are closer than two random tracks in an embedding space. To leverage this information, each track is represented by another n-dimensional real-valued vector (e.g., n=60, 80 or 100) acquired in modality encoder 406-2. These track representations are based on track co-occurrences in playlists, meaning that two tracks are likely to be near each other in the embedding space if they co-occur in playlists and vice-versa.

In some embodiments, the acoustic embeddings 405 and collaborative embeddings 407, in conjunction with other user features such as additional features 408 (e.g., user demographic features) and user context features 410, form input features x and undergo the main model training to produce the user representations, z. In some embodiments, the input features for user u are constructed and vectorized as

$${x}_{u} = [ {c}_{u} , {a}_{u} , {v}_{u} ] , \qquad ( 1 )$$

where aᵤ and vᵤ show the aggregate over audio embeddings and the collaborative embeddings of tracks consumed by user u, respectively.

The autoencoder model 420 aims to find zᵤ∈R^{k} such that it minimizes the loss function:

$$L = \frac{1}{U} {\sum }_{u = 1}^{U} ‖ {x}_{u} - {f}_{dec} ( {f}_{enc} ( {x}_{u} ) ) ‖$$

$$where {z}_{u} = {f}_{enc}^{*} ( {x}_{u} )$$

for the optimal encoder

$${f}_{enc}^{*} .$$

Reconstruction loss allows the weights of the model to be updated with the goal to summarize user features. This is in contrast with model architectures that prefer next item prediction. Accordingly, the model learns about the user holistically by summarizing them instead of being just good at next action prediction.

Algorithm 1 below summarizes the overall training steps. A stochastic optimization is used on random batches of users to train the autoencoder model and produce user representations.

Algorithm 1: Training Generalized User Representation

```
Input: Matrices C, A, V.
while not converged do
  Sample a batch of users D
  For u ∈ D construct xᵤ as
  xᵤ = [cᵤ, aᵤ, vᵤ]
  zᵤ = f_{enc}(xᵤ)
  $Compute {L}_{D} = \frac{1}{D} {\sum }_{u = 1}^{U} ‖ {x}_{u} - {f}_{dec} ( {f}_{enc} ( {x}_{u} ) ) ‖$
  Compute the aggregate gradient from this batch
  Update f enc and f dec by taking the gradient step.
End while
$Output : {f}_{enc}^{*} and {f}_{dec}^{*}$
```

With continued reference to FIG. 4, in some embodiments, the second stage of two-stage process involves deploying, to downstream tasks models 424, generalized representations of users in the representation space (Z_{U}) 418, where each task model 424 is configured to be trained to perform a respective (e.g., distinct) task. Some examples of tasks include ranking, search, music recommendation, and discovery.

In some embodiments, the autoencoder model 420 outputs a 120-dimensional user representation that is available to be used for all downstream tasks. In some embodiments, the autoencoder model 420 is trained in isolation from downstream tasks and is retrained once every few months. In some embodiments, the schedule of its retraining is synchronized with upstream modality encoder retraining. Once the autoencoder model 420 finishes retraining, downstream models perform their own retraining.

In some embodiments, batch inference and near-real time inference are combined for user representation. In some embodiments, batch inference pipelines run once daily for over 600 million users and/or run according to another schedule. Near-real time inference happens multiple times throughout the day depending on user activity.

FIGS. 5A and 5B illustrate output embeddings that are output by modality encoders 406 over different time horizons, in accordance with some embodiments. In the example of FIG. 5A, modality encoder 406-1 outputs acoustic embeddings 405, which are aggregated to form aggregated acoustic embeddings 502. FIG. 5B shows modality encoder 406-2 output collaborative embeddings 407, which are then aggregated to form aggregated collaborative embeddings 504. In some embodiments, the aggregated embeddings can be aggregated over different time spans, such as one week, two weeks, one month, six months, or other time horizons. A key advantage of using multiple time frame based features is that the model can keep a “core” understanding of a user while being sensitive to the user's recent taste changes.

FIG. 5C illustrates modality encoder 406-3 processing new user onboarding signals 510 to generate new user onboarding embeddings 512, in accordance with some embodiments. New user onboarding signals 510 can include information of artists and/or language selected by new users. In some embodiments, the features described above (e.g., acoustic embeddings 405, collaborative embeddings 407, aggregated acoustic embeddings 502, aggregated collaborative embeddings 504, additional information 408 (e.g., demographics features or other user features), and/or context features 410) are combined with new user onboarding embeddings 512 to generate the audio embedding space 412.

According to some embodiments, the autoencoder model 420 accepts not just music streaming signals at different time frames, but also as embeddings of other content information on the media content platform such as podcast listening. This allows the user representation to be universally useful across content types for recommendation tasks. FIG. 6 illustrates music modality encoder 406-4, podcast modality encoder 406-5, and other modality encoders 406-6 can generate respective embeddings (e.g., corresponding to music listening and podcast listening) that feed into the user representation model 602 (e.g., audio embedding space 412), which is then applied to downstream tasks 604.

### Transfer Learning Methodology

Transfer learning enables re-use of knowledge gained from a pretrained model on new problems in downstream tasks such as ranking, search, music recommendation and discovery, as described with respect to FIG. 4. This section presents a methodology of implementing transfer learning with user representation for large scale recommendation tasks.

FIG. 7 depicts three task models 702, 704, and 706 that require user information. Without transfer learning (left of FIG. 7), common user features are individually curated and fed into each model. With transfer learning (right of FIG. 7), common user features are instead condensed into a generalized user representation 708 that can be fed directly into downstream task models. By utilizing a generalized universal user representation instead of individual user features, the amount of feature engineering and model complexity required in downstream models can be reduced.

In some embodiments, the task models include a classification model that is configured to perform a classification task. Classification models are useful in tasks that require a system to know affinity or likelihood of engagement with a piece of content. An example of one such classifier is an artist preference model. It is a binary classifier that predicts a user's likelihood to follow an artist. The outputs of this model are used by teams that rank artists to show to users in cover art of playlists as well as in picking artists in playlist personalization tasks. User representation that captures user interest holistically and responds quickly to user interest is crucial to success.

In some embodiments, the task models include a candidate generation model. Candidate generation models can be applied in the first few stages of a recommender system. A candidate generation model identifies one or more content items (e.g., media content items) for recommendation to a user via nearest neighbor lookups. An example candidate generation model is a two-tower model. The first tower obtains user features and the second tower obtains item features, which are then passed through multiple hidden layers of a dense neural network. In some embodiments, the candidate generation model is tuned using dot product over the embeddings from the last layer of the two towers to bring them into the same vector space for nearest neighbor lookups in candidate generation tasks. The candidate generation model is key to user representation that is cold-start aware, because being able to identify correct items to show to new users in their first few sessions is key to ensuring continued user engagement with the media content platform.

In some embodiments, the task models include an item ranking model that is configured to determine an order of pieces of content to be presented to a user. An example ranking model can perform listwise ranking of items and re-orders them in an order that is personalized for a user. Ranking models can have a simpler architecture while gaining all the capabilities of user representation. User representation that quickly responds to changing user taste may be crucial in such models.

In accordance with some embodiments, user representation should respond quickly to user listening behaviors and interactions. Batch inference systems take 2-3 days to respond to taste changes, which may not be fast enough for a variety of downstream tasks. Representation at any point in time should reflect the latest information about user taste and continue to get updated with activity.

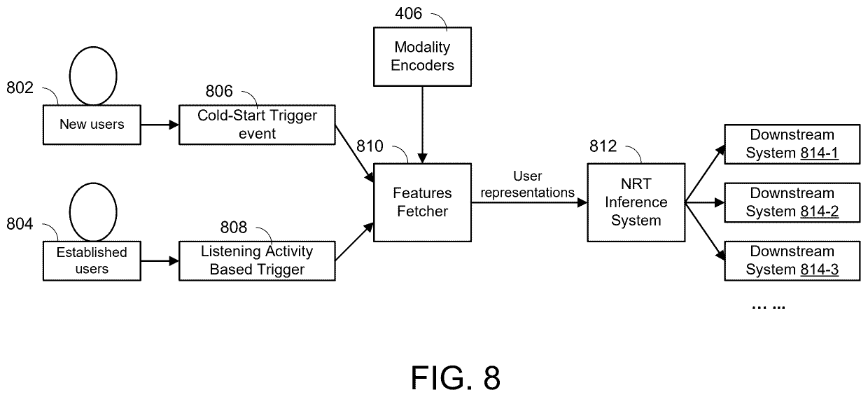

In some embodiments, to quickly respond to user listening behaviors and interactions, Near-Real Time (NRT) inference is applied. Building out an event driven system to power NRT inference allows the representation to quickly respond to user taste. FIG. 8 illustrates near-real time inference system 812 of user representations, in accordance with some embodiments. Event streams act as triggers (e.g., listening activity based trigger 808) and carry input features (e.g., via features fetcher 810) based on users' listening activities. This event queue is subscribed by the backend services, which pre-process events into model consumable features and make inferences in near-real time. In some embodiments, the user representations are ingested into a low-latency serving system, which provides access to the most up-to-date representation to all downstream services. In some embodiments, NRT is combined with batch inference to produce representation for active users as well as users who return to the platform after some inactivity.

### Cold-Start Awareness

User representation should work well for new users 802 as much as established users 804, and should get better with time. In some embodiments, new users 802 can select, via an application associated with the media content platform, artists and/or language during the onboarding process. However, in some instances, only a portion of new users complete the full onboarding process. As shown in FIG. 8, in some embodiments, a separate event trigger 806 is used with the onboarding signals. Artists selected during onboarding are passed to the modality encoder(s) 406, which convert them to embeddings. Language selections are converted to a multi-hot encoded list. Embeddings for new users are created by the same model (e.g., features fetcher 810) used for established users 804. The embeddings are available for immediate use by downstream models (e.g., downstream system 814-1, downstream system 518-2 and/or downstream system 814-3) (e.g., also described herein as downstream task models 424 (FIG. 4), downstream tasks 604 (FIG. 6), and/or model A 702, model B 704, and model C 706 (FIG. 7)) via a low-latency serving system. When new user onboarding signals are available, these new user onboarding signals are used alongside demographic features. In absence of new user onboarding signals, the signals are imputed and demographic and other static features are used. As users become more established on the platform, the model keeps inferring with onboarding selections alongside other listening history for a few months. After this point, new user onboarding signals no longer play a role in inference for a user. This is to ensure that personalization experience gracefully transitions from a user being cold-start to becoming established.

In transfer learning, the outputs of an “upstream” model are fed into one or more “downstream” models, effectively forming a directed acyclic graph. For generality, note that these are general terms and a model can serve as both “downstream” to some models and “upstream” to others. In some embodiments, in order for the user representation model to be generally usable for transfer learning, user representations and their respective modality encoders should exist in “stable” vector spaces. A stable vector space is one in which item embeddings are only either added or updated after its initial training, without significantly changing the latent meaning of the individual vector space dimensions. In comparison to a vector space model which is retrained daily (in order to add and update items, for example), a stable vector space can be safely interpreted by downstream models without needing to retrain the downstream models as new items come into existence. However, in order to account for model drift, feature and hyperparameter updates, etc., even stable vector spaces require retraining, albeit on a much less frequent cadence. Due to this, transfer learning introduces a challenge wherein changes to upstream models necessitate retraining downstream models to maintain compatibility. If an upstream model is retrained, downstream models must follow suit to avoid model failure or unpredictable outcomes due to data drift.

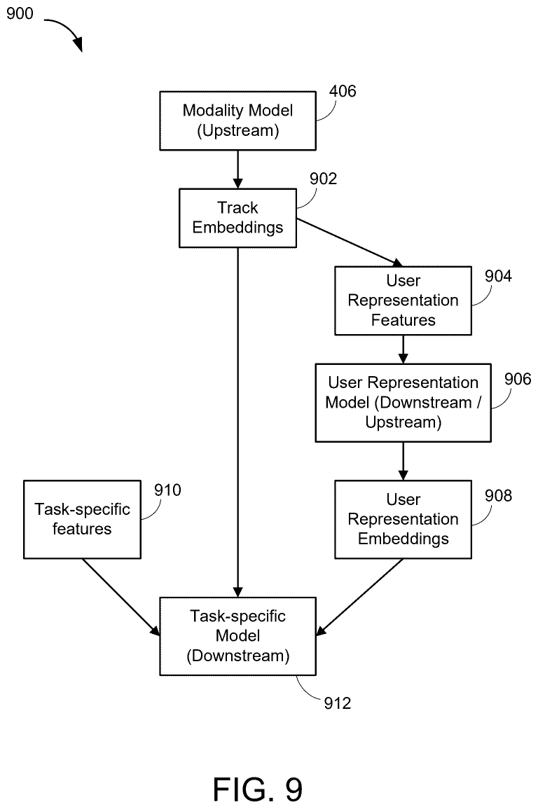

To address this, some embodiments propose a “batch management” strategy that ensures synchronization across models in a transfer learning chain. FIG. 9 illustrates an example transfer learning model chain 900 that includes batch management, in accordance with some embodiments. In some embodiments, a modality encoder 406 produces track embeddings 902, which are included in user representation features 904 and input into a user representation model 906. The resulting user representations (e.g., user representation embeddings 908) are further fed into a task-specific downstream model 912 alongside track embeddings and other task-specific features 910. Retraining the modality embedding model necessitates subsequent retraining of the user representation model and the task-specific model in that specific order.

In some embodiments, key aspects of the “batch management” strategy include:
Batch Identification: Retraining an embedding/vector space model results in a new “batch” with a tracked identifier allowing tracking of changes in vector space dimensions;
Synchronization: In some embodiments, each model in the transfer learning chain is synchronized with respect to model retraining of its respective upstream models;
Upstream Retrains: Models can be retrained independently as needed. However, when any upstream model is retrained, all models which are downstream of it in the chain must automatically retrain;
Consistent Comparisons: Downstream models should only compare embeddings within the same upstream batch(es)
Training and Inference: Downstream models must use the same upstream batch(es) for both training and making predictions to ensure consistency; and
Continuous Production: Models in production can continue making up-to-date predictions during retraining.

In some embodiments, to manage the complexity and resource consumption, each model is limited to two concurrent batches-the “current” and “legacy” batches. “Batch rotation” occurs when a model completes training, pushing the new model into the current batch and rotating the previous batch to legacy. After an upstream batch rotation, downstream models switch to using the legacy batch for offline and/or online inference while simultaneously retraining on the current batch. Once their retraining is complete, downstream models switch back to using the current batch for production. In some embodiments, leveraging transfer learning and batch management can reduce compute, manpower and infrastructure costs.

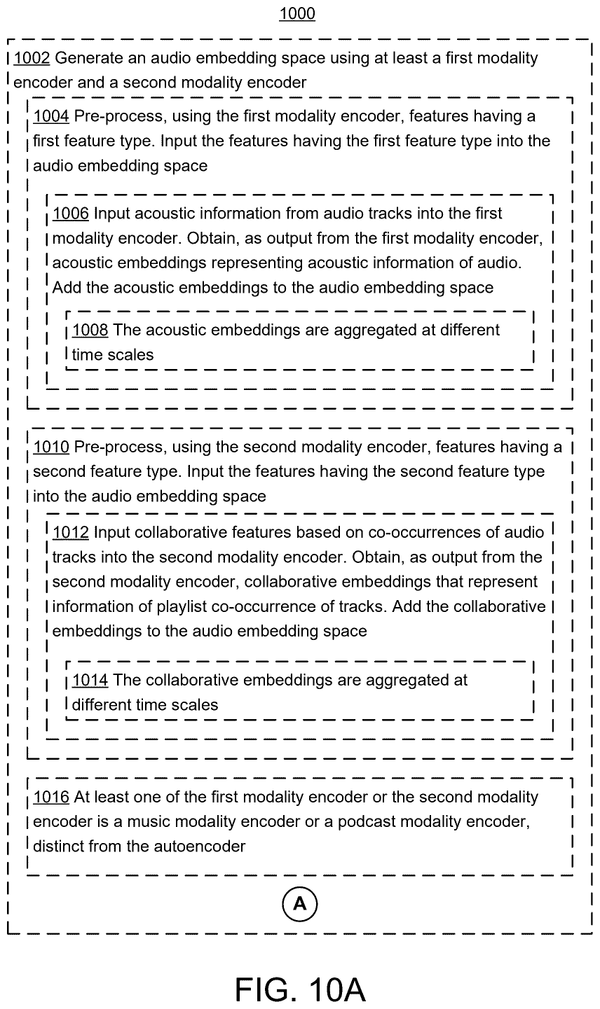

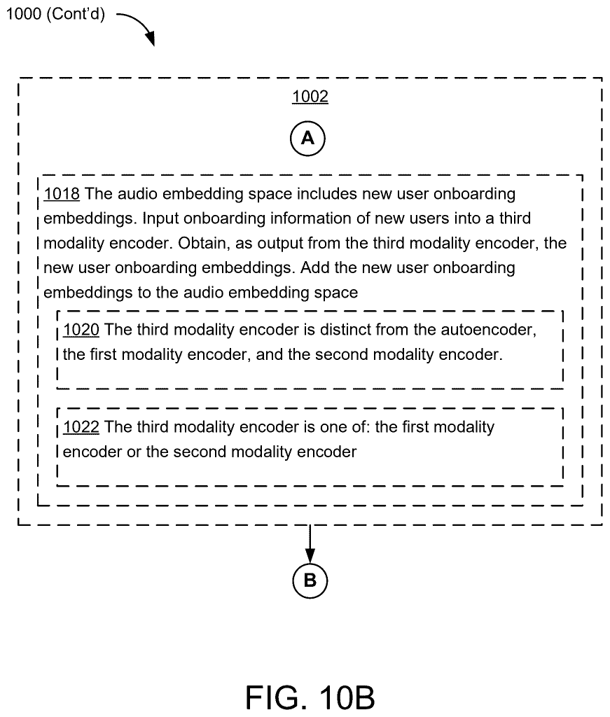

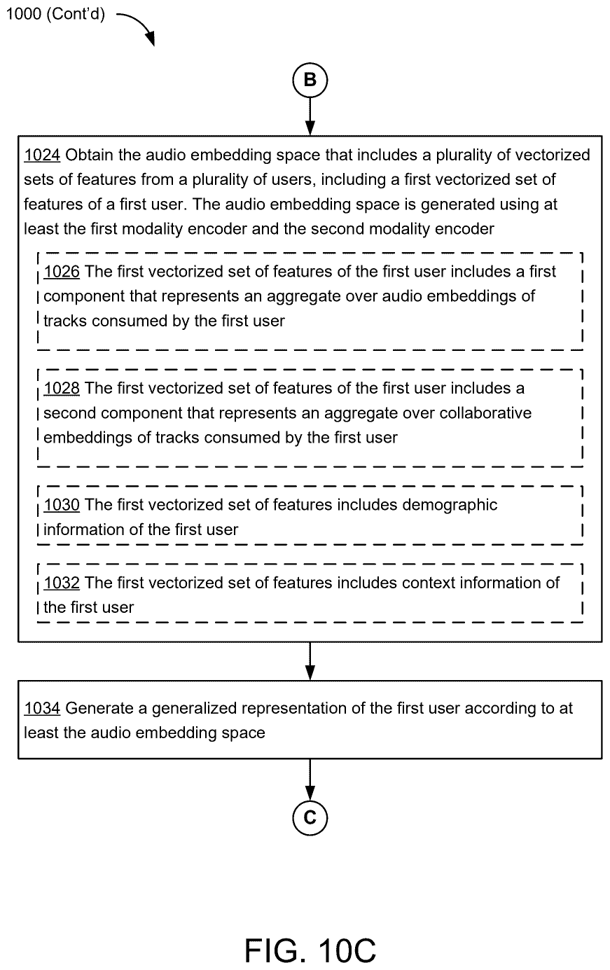

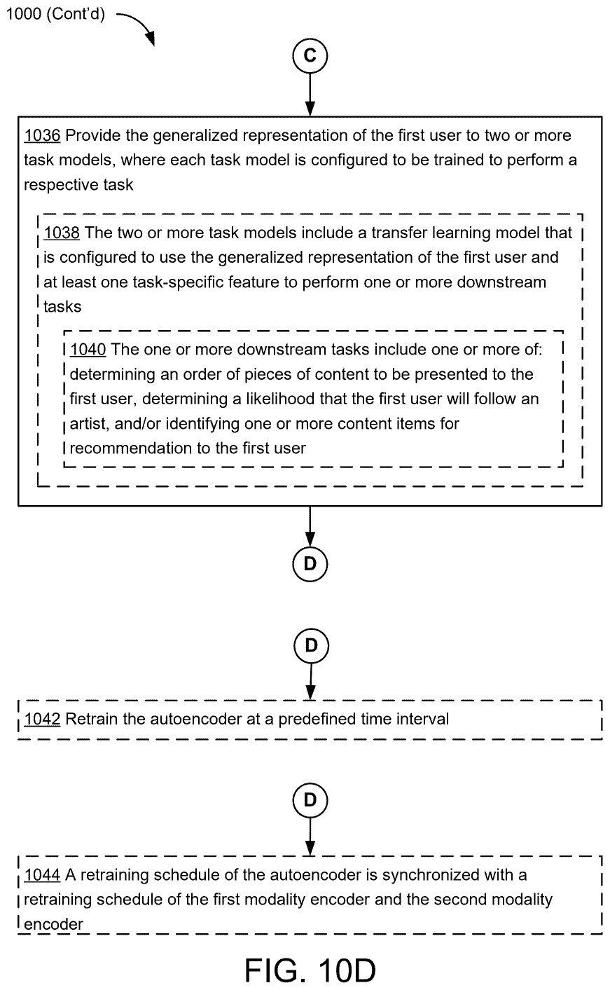

FIGS. 10A-10D are flow diagrams illustrating a method 1000 of generating a generalized representation of users, in accordance with some embodiments. Method 1000 may be performed at a computing system (e.g., media content server 104 and/or electronic device(s) 102) that optionally executes an autoencoder (e.g., autoencoder module 230, autoencoder module 322, autoencoder model 420). The computing system includes one or more processors and memory storing instructions for execution by the one or more processors. In some embodiments, the method 1000 is performed by executing instructions stored in the memory (e.g., memory 212, FIG. 2, memory 306, FIG. 3) of the computing system. In some embodiments, the method 1000 is performed by a combination of the server system (e.g., including media content server 104 and CDN 106) and a client device. In some embodiments, the operations shown in FIGS. 1-9 correspond to instructions stored in the memory or other non-transitory computer-readable storage medium. The computer-readable storage medium may include a magnetic or optical disk storage device, solid state storage devices such as Flash memory, or other non-volatile memory device or devices. In some embodiments, the instructions stored on the computer-readable storage medium include one or more of: source code, assembly language code, object code, or other instruction format that is interpreted by one or more processors. Some operations in the method 1000 may be combined and/or the order of some operations may be changed.

Referring now to FIG. 10A, in some embodiments, in performing the method 1000, the computing system generates (1002) an audio embedding space (e.g., XU 412) (e.g., a vector space) using at least a first modality encoder (e.g., modality encoder 406-1) and a second modality encoder (e.g., modality encoder 406-2).

In some embodiments, the computing system pre-processes (1004), using the first modality encoder, features having a first feature type, and inputs the features having the first feature type into the audio embedding space.

In some embodiments, the features having the first feature type include content-based features for music, or content-based features for podcast, or collaborative features for music, or collaborative features for podcast. For example, as described with reference to FIG. 4, modality encoder 406-1 pre-processes audio features 402 and/or modality encoder 406-2 pre-processes collaborative features 404.

In some embodiments, the features having the first feature type comprises audio features (e.g., audio features 402). In some embodiments, the computing device inputs (1006) acoustic information from audio tracks into the first modality encoder; obtains, as output from the first modality encoder, acoustic embeddings (e.g., acoustic embeddings 405) representing acoustic information of audio; and adds the acoustic embeddings to the audio embedding space.

In some embodiments, the acoustic embeddings are aggregated (1008) at different time scales (e.g., one week, one month, six months, or other time scales/time spans). For example, as described with reference to FIGS. 5A-5B, embeddings (e.g., acoustic embeddings 405) are aggregated over different time horizons.

In some embodiments, the computing system pre-processes (1010), using the second modality encoder, features having a second feature type, and inputs the features having the second feature type into the audio embedding space.

In some embodiments, the features having the second feature type include content-based features for music, or content-based features for podcast, or collaborative features for music, or collaborative features for podcast. In some embodiments, the first and second feature types can both be content features, one for music and one for podcast. In some embodiments, the first and second feature types can both be collaborative features, one for music and one for podcast. In some embodiments, a respective modality encoder pre-process features corresponding to a respective content type (e.g., music, podcast, live events, or video).

In some embodiments, the features having the second feature type comprises collaborative features (e.g., collaborative features 404). In some embodiments, the computing system inputs (1012) collaborative features based on co-occurrences of audio tracks (e.g., audio tracks, tracks in a podcast) into the second modality encoder; obtains, as output from the second modality encoder, collaborative embeddings (e.g., collaborative embeddings 407) that represent information of playlist co-occurrence of tracks; and adds the collaborative embeddings to the audio embedding space.

In some embodiments, the collaborative embeddings are aggregated (1012) at different time scales (e.g., one week, one month, six months, or other time scales/time spans). For example, as described with reference to FIGS. 5A-5B, embeddings (e.g., collaborative embeddings 407) are aggregated over different time horizons.

In some embodiments, at least one of the first modality encoder or the second modality encoder is (1016) a music modality encoder (e.g., music modality encoder 406-4) or a podcast modality encoder (e.g., music modality encoder 406-5), distinct from the autoencoder that generates the generalized representation of the first user.

Referring to FIG. 10B, in some embodiments, the audio embedding space includes (1018) new user onboarding embeddings (e.g., new user onboard embeddings 512, corresponding to new users of the media content platform), as described with reference to FIG. 8. The computer system inputs onboarding information of new users into a third modality encoder (e.g., modality encoder 406-3); obtains, as output from the third modality encoder, the new user onboarding embeddings; and adds the new user onboarding embeddings to the audio embedding space.

In some embodiments, the new user onboarding information includes information of artists and/or language selected by the new users. In some embodiments, when new user onboarding signals are available, these signals are used alongside demographic features, e.g., from a user profile provided by the user to the media-content platform. In some embodiments, in the absence of new user onboarding signals, demographic and other static features are used. In some embodiments, as users become more established on the platform, the media content delivery system keeps inferring with onboarding selections alongside other playback history (e.g., for a few months). After this point, new user onboarding signals no longer play a role in inference for a user. This is to ensure that personalization experience gracefully transitions from a user being cold-start (e.g., using cold-start awareness described with reference to FIG. 8) to becoming established.

In some embodiments, the third modality encoder is (1020) distinct from the autoencoder that generates the generalized representation of the first user, the first modality encoder, and the second modality encoder.

In some embodiments, the third modality encoder is one (1022) of the first modality encoder or the second modality encoder.

Referring to FIG. 10C, the computing system obtains (e.g., receives or generates)(1024) the audio embedding space that includes a plurality of vectorized sets of features from a plurality of users, including a first vectorized set of features (e.g., a vector space, a set of embedding vectors, a set of feature vectors) of a first user. The audio embedding space is generated using at least the first modality encoder and the second modality encoder as discussed above with reference to FIGS. 10A and 10B.

In some embodiments, the first vectorized set of features of the first user includes (1026) a first component that represents an aggregate over audio embeddings of tracks consumed by the first user (e.g., tracks in a playback history of the user), as described with reference to equation (1).

In some embodiments, the first vectorized set of features of the first user includes (1028) a second component that represents an aggregate over collaborative embeddings of tracks consumed by the first user, as described with reference to equation (1).

In some embodiments, the first vectorized set of features includes (1030) demographic information (e.g., additional information 408) of the first user. Some examples of demographic information include a country of registration, device(s) used by the first user, and activity such as number of track plays.

In some embodiments, the first vectorized set of features includes (1032) context information (e.g., context features 410) of the first user. Examples of context information can include a user's time zone, a time of day, a user's location, and a type of device that the user is using.

The computing system generates (1034) a generalized representation of the first user according to at least the audio embedding space. For example, generalized representations of users in the representation space (ZU) 418.

The computing system provides (1036) the generalized representation of the first user to two or more task models (e.g., downstream task models 424), where each task model configured to be trained to perform a respective task, as described with reference to FIG. 4.

In some embodiments, the two or more task models include (1038) a transfer learning model that is configured to use the generalized representation of the first user and at least one task-specific feature to perform one or more downstream tasks, as described with reference to FIG. 7.

In some embodiments, the one or more downstream tasks include (1040) one or more of: determining an order of pieces of content (e.g., audio, podcast, video, upcoming live events) to be presented to the first user (e.g., ranking content items), determining a likelihood that the first user will follow an artist, and/or identifying one or more content items for recommendation to the first user.

In some embodiments, the autoencoder that generates the generalized representation of the first user is retrained (1042) at a predefined time interval.

In some embodiments, a retraining schedule of the autoencoder that generates the generalized representation of the first user is synchronized (1044) with a retraining schedule of the first modality encoder and the second modality encoder.

Although FIGS. 10A-10D illustrate a number of logical stages in a particular order, stages which are not order dependent may be reordered and other stages may be combined or broken out. Some reordering or other groupings not specifically mentioned will be apparent to those of ordinary skill in the art, so the ordering and groupings presented herein are not exhaustive. Moreover, it should be recognized that the stages could be implemented in hardware, firmware, software, or any combination thereof.

The foregoing description, for purpose of explanation, has been described with reference to specific embodiments. However, the illustrative discussions above are not intended to be exhaustive or to limit the embodiments to the precise forms disclosed. Many modifications and variations are possible in view of the above teachings. The embodiments were chosen and described in order to best explain the principles and their practical applications, to thereby enable others skilled in the art to best utilize the embodiments and various embodiments with various modifications as are suited to the particular use contemplated.

What is claimed is:

1. A method for generating a generalized representation of users, performed by a computing system, the method comprising:
obtaining an audio embedding space that includes a plurality of vectorized sets of features from a plurality of users, including a first vectorized set of features of a first user, wherein the audio embedding space is generated using at least:
a first modality encoder that pre-processes features having a first feature type into the audio embedding space; and
a second modality encoder that pre-processes features having a second feature type into the audio embedding space,
generating a generalized representation of the first user according to at least the audio embedding space; and
providing the generalized representation of the first user to two or more task models, each task model configured to be trained to perform a respective task.

2. The method of claim 1, wherein obtaining the audio embedding space includes generating the audio embedding space using at least the first modality encoder and the second modality encoder.

3. The method of claim 1, wherein at least one of the first modality encoder or the second modality encoder is a music modality encoder or a podcast modality encoder, distinct from an autoencoder that generates the generalized representation of the first user.

4. The method of claim 1, further comprising:
prior to receiving the audio embedding space:
inputting acoustic information from audio tracks into the first modality encoder;
obtaining, as output from the first modality encoder, acoustic embeddings representing acoustic information of audio; and
adding the acoustic embeddings to the audio embedding space.

5. The method of claim 4, wherein the acoustic embeddings are aggregated at different time scales.

6. The method of claim 1, further comprising:
prior to receiving the audio embedding space:
inputting collaborative features based on co-occurrences of audio tracks into the second modality encoder;
obtaining, as output from the second modality encoder, collaborative embeddings that represent information of playlist co-occurrence of tracks; and
adding the collaborative embeddings to the audio embedding space.

7. The method of claim 6, wherein the collaborative embeddings are aggregated at different time scales.

8. The method of claim 1, wherein:
the audio embedding space includes new user onboarding embeddings; and
the method includes, prior to receiving the audio embedding space:
inputting onboarding information of new users into a third modality encoder;
obtaining, as output from the third modality encoder, the new user onboarding embeddings; and
adding the new user onboarding embeddings to the audio embedding space.

9. The method of claim 8, wherein the third modality encoder is distinct from an autoencoder that generates the generalized representation of the first user, the first modality encoder, and the second modality encoder.

10. The method of claim 8, wherein the third modality encoder is one of: the first modality encoder or the second modality encoder.

11. The method of claim 1, wherein the first vectorized set of features of the first user includes a first component that represents an aggregate over audio embeddings of tracks consumed by the first user.

12. The method of claim 11, wherein the first vectorized set of features of the first user includes a second component that represents an aggregate over collaborative embeddings of tracks consumed by the first user.

13. The method of claim 1, wherein the first vectorized set of features includes context information of the first user.

14. The method of claim 1, wherein the two or more task models include a transfer learning model that is configured to use the generalized representation of the first user and at least one task-specific feature to perform one or more downstream tasks.

15. The method of claim 14, wherein the one or more downstream tasks include one or more of:
determining an order of pieces of content to be presented to the first user,
determining a likelihood that the first user will follow an artist, and/or
identifying one or more content items for recommendation to the first user.

16. The method of claim 1, wherein an autoencoder that generates the generalized representation of the first user is retrained at a predefined time interval.

17. The method of claim 1, wherein a retraining schedule of an autoencoder that generates the generalized representation of the first user is synchronized with a retraining schedule of the first modality encoder and the second modality encoder.

18. A computing system, comprising:
one or more processors; and
memory storing one or more programs, the one or more programs including instructions for:
generating an audio embedding space that includes a plurality of vectorized sets of features from a plurality of users, including a first vectorized set of features of a first user, wherein the audio embedding space is generated using at least:
a first modality encoder that pre-processes features having a first feature type into the audio embedding space; and
a second modality encoder that pre-processes features having a second feature type into the audio embedding space,
generating a generalized representation of the first user according to at least the audio embedding space; and
providing the generalized representation of the first user to two or more task models, each task model configured to be trained to perform a respective task.

19. The computing system of claim 18, wherein at least one of the first modality encoder or the second modality encoder is a music modality encoder or a podcast modality encoder, distinct from an autoencoder that generates the generalized representation of the first user.

20. A non-transitory computer-readable storage medium storing one or more programs for execution by a computing system having one or more processors and memory, the one or more programs comprising instructions for:
generating an audio embedding space that includes a plurality of vectorized sets of features from a plurality of users, including a first vectorized set of features of a first user, wherein the audio embedding space is generated using at least:
a first modality encoder that pre-processes features having a first feature type into the audio embedding space; and
a second modality encoder that pre-processes features having a second feature type into the audio embedding space,
generating a generalized representation of the first user according to at least the audio embedding space; and
providing the generalized representation of the first user to two or more task models, each task model configured to be trained to perform a respective task.
